(19) United States
(12) Patent Application Publication
(10) Pub. No.: US 2026/0202867 A1
(43) Pub. Date: Jul. 16, 2026

(54) METHOD OF OPERATING A HEAT SUPPLY SYSTEM

(71) Applicant: CSEM CENTRE SUISSE D'ELECTRONIQUE ET DE MICROTECHNIQUE SA - RECHERCHE ET DÉVELOPPEMENT, Neuchâtel (CH)

(72) Inventors: Andreas HUTTER, Neuchâtel (CH); Yves STAUFFER, Epalinges (CH); Max BOEGLI, Couvet (CH); Nelson KOCH, Tafers (CH); Tomasz GORECKI, Lausanne (CH); Renaud LANGOU, Neuchâtel (CH)

(21) Appl. No.: 19/136,201

(22) PCT Filed: Dec. 5, 2023
(86) PCT No.: PCT/EP2023/084368

§ 371 Date: Jun. 5, 2025

(30) Foreign Application Priority Data
Dec. 6, 2022 (EP) 22211590.9

(51) Int. Cl. G05D 23/19

(52) U.S. Cl. CPC G05D 23/1917

(57) ABSTRACT

A method of operating a heat supply system including a heat source and heat transfer fluid, a system controller controlling an outlet temperature of the fluid based on a heating curve defining a raw outlet temperature in inverse proportion to an outside temperature, and heat exchangers receiving the fluid and having a respective controllable valve, the controllable valve being associated with a flow rate measurement transmitted to the system controller. The system controller performs steps of: receiving signals relating to the flow rate measurements; calculating a weighted average of the flow rate measurements; adding an offset to the raw outlet temperature based on the weighted average to give an offset raw outlet temperature such that a decrease in the weighted average decreases the outlet temperature, and an increase in the weighted average increases the outlet temperature; and determining the outlet temperature based on the offset raw outlet temperature.

### CROSS-REFERENCE TO RELATED APPLICATIONS

This application is the U.S. national phase of International Application No. PCT/EP2023/084368 filed Dec. 5, 2023 which designated the U.S. and claims priority to EP 22211590.9 filed Dec. 6, 2022, the entire contents of each of which are hereby incorporated by reference.

The project leading to this application has received funding from the European Union's Horizon 2020 Research and Innovation Programme under grant agreement No. 894240.

### TECHNICAL FIELD

The present invention relates to the field of heat supply, particularly for a building or for a district heating system. More particularly, it relates to a method of operating a heat supply system.

### STATE OF THE ART

In a heating system, whether it be for a building or a district heating system, it is common to control the outlet temperature of the heat generator on the basis of a heating curve, in which the temperature to which the heat transfer fluid (typically water) is heated varies in an inverse relation to the outside air temperature. As a result, the outlet temperature is reduced when the outside air temperature increases, and vice-versa. This approach is often augmented by rule-based logic, such as a higher heating curve (and hence higher outlet temperature) during the day than at night.

The heating curve, and any variation thereof, is typically set so as to avoid complaints of users feeling cold, which may result in an expensive call-out of a technician. As a result, there is a tendency to over-heat the heat transfer fluid, so that the user can usually still increase the heat output from his or her heat exchangers (typically radiators) by adjusting the thermostatic valves. As a result, the opening position of the thermostatic valves tends to be more closed than is optimal, resulting in increased heat losses in the conduits due to higher-than-optimal temperatures of the heat transfer fluid, and heat generators running at lower efficiencies due to the inlet temperatures being higher than they could otherwise be. As a general rule, heat generators such as gas boilers and heat pumps are most efficient with a lower inlet temperature, and hence an optimal solution for maximizing the coefficient of performance (COP) of the heat generator seeks to lower the inlet temperature.

Various solutions to this problem are known in the art, which typically use the most limiting thermostatic valve as a reference. For instance, the method disclosed in EP2912384 seeks to ensure that the most limiting valve is almost 100% open, and will adjust the outlet temperature of the heat generator to achieve this. A major problem with this approach is that by basing the outlet temperature on one limiting valve, the remaining valves may tend to run more closed than would be optimal.

WO2012/020205 discloses various methods of operating a heat pump system, one of which involves measuring the maximum opening position of each thermostatic valve over a given period, and then adjusting the heating curve on the basis of the average of the maximum opening positions measured within said given period. Using the maximum opening positions over a particular time period is an improvement over using only the most limiting valve as a reference, but reduces the ability of the system to adapt quickly to sudden changes, and in the case of valves opening and closing fairly rapidly to respond to changing conditions, the sub-periods in which the valves are more closed are missed. This results in an increased risk of under-heating.

The aim of the present invention is hence to propose a method of operating a heat supply system in which the above-mentioned drawbacks are at least partially overcome.

### DISCLOSURE OF THE INVENTION

More precisely, the invention relates to a method of operating a heat supply system. This heat supply system comprises:
a heat source, such as a gas or oil boiler, a heat pump or similar, adapted to heat a heat transfer fluid such as water which may or may not contain an additive;
a system controller adapted to control said heat source so as to determine an outlet temperature of said heat transfer fluid at an outlet of said heat source on the basis of a heating curve defining a raw outlet temperature of said heat source in inverse proportion to an outside temperature, typically measured with a temperature sensor situated outside the building concerned, the heating curve typically being linear but this does not have to be the case;
at least two heat exchangers such as radiators, forced air heat exchangers or similar, each adapted to receive said heat transfer fluid and provided with a respective controllable valve (e.g. a thermostatic valve or any other form of controllable valve) at an inlet or outlet thereof, said controllable valve being associated with a direct or indirect flow rate measurement (such as direct measurement by a flow meter or an indirect measurement such as valve position) transmitted to said controller.

The method comprises said system controller carrying out steps of:
receiving signals relating to said direct or indirect flow rate measurements associated with said controllable valves, these signals corresponding to the controllable valves' current respective direct or indirect flow rate measurements;
calculating a weighted average of said direct or indirect flow rate measurements;
adding an offset (which may be positive or negative) to said raw outlet temperature on the basis of said weighted average (whether alone or in combination with another parameter, as discussed below) to give an offset raw outlet temperature such that, when said weighted average decreases said offset raw outlet temperature decreases, and when said weighted average increases, said offset raw outlet temperature increases;
determining said outlet temperature directly or indirectly on the basis of said offset raw outlet temperature.

This method results in the controllable valves being on average more open than under a classical approach, with higher flow rates of heat transfer fluid and lower outlet temperature of the heat source, resulting in lower inlet temperatures for this latter, increasing its coefficient of performance, without resorting to significant underheating. Compared to the prior art approaches outlined above, using the average direct or indirect flow rate measurements results in better results than using a most-limiting valve, which tends to result in the remaining valves being more closed than would be optimal and the outlet temperature being higher than necessary, and is not only far more responsive than using a time-averaged maximum of direct or indirect flow rate measurements (such as indirect flow rate measurements relating to valve opening positions), but is also applicable to systems incorporating flow-rate meters arranged to directly measure the flow rate.

Typically, said weighted average weights each controllable valve equally, but this does not have to be the case.

Advantageously, said offset is determined based on a difference between a valve direct or indirect flow rate reference STVflow_{ref} and the average of the direct or indirect flow rate measurements of all of said controllable valves STVflow_{avg}.

Advantageously, said average of the direct or indirect flow rate measurements of all of said controllable valves STVflow_{avg} is defined as:

$${STVflow}_{avg} = \frac{1}{N} {\sum }_{n = 1}^{N} {wp}_{n} {STVflow}_{n} , \qquad Equation 1$$

where N is the number of controllable valves, STVflowₙ the valve n direct or indirect flow rate measurement, and wpₙ the weight attributed to the valve n. In the normal case, wpₙ=1 for all n.

Advantageously, said offset raw outlet temperature is low-pass filtered to give a filtered offset raw outlet temperature, said outlet temperature being based on said filtered offset raw outlet temperature, in order to prevent rapid cycling and oscillation of the outlet temperature of the heat source.

Advantageously, the first differential of the average controllable valve temperature setpoint STVspT_{avg} is amplified and low-pass filtered then added to said filtered offset raw outlet temperature to determine said outlet temperature.

Advantageously, the average controllable valve temperature setpoint STVspT_{avg} is defined as:

$${STVspT}_{avg} = \frac{1}{N} {\sum }_{n = 1}^{N} {wt}_{n} {STVspT}_{n} , \qquad Equation 2$$

where N is the number of valves, STVspTₙ the valve n temperature setpoint, and wtₙ the weight attributed to the valve n. In the normal case, wtₙ=1 for all n.

Advantageously, a gain K_{P} is applied to said difference between a valve direct or indirect flow rate reference STVflow_{ref} and the average of the direct or indirect flow rate measurements of all of said controllable valves STVflow_{avg}. This gain K_{P} can be varied so as to be lower during a warmer season, and higher during a cooler season. The season can either be predetermined based on a calendar, or by measuring the average outdoor temperature over a certain period such as a few days or a few weeks.

Advantageously, day/night variation in heat supply is obtained exclusively by varying each controllable valve temperature setpoint. In essence, the typical day/night variation in outlet temperature is obtained automatically by applying the method of the invention, provided that the user has set a day/night temperature schedule on the controllable valves. This reduces the risk of overheating and underheating.

Advantageously, said controllable valves are thermostatic valves, and said direct or indirect flow rate measurement is related to (i.e. is a function of) an opening position of each of said controllable valves.

Alternatively, said controllable valves are each associated with a respective flow rate meter, and said direct or indirect flow rate measurement is a flow rate measured by each of said flow rate meters.

### BRIEF DESCRIPTION OF THE FIGURES

Further details of the invention will appear more clearly upon reading the following description, in reference to the appended figures in which:

FIG. 1 illustrates a heat supply system of the type typical for a building;

FIG. 2 illustrates a schematic representation of a controller;

FIG. 3 contains graphs showing the effect of fixed parameters on the heating curve;

FIG. 4 contains graphs showing the effect of variable parameters on the heating curve;

FIG. 5 illustrates a heat supply system of the type typical for district heating;

FIG. 6 illustrates the setup of a test installation in a building used for assessment of the performance of the method of the invention;

FIG. 7 is a graph of normalized daily energy results for the whole building used as a test setup, normalized at 0° C. outdoor temperature in reference to the baseline measurements and all heating circuits being aggregated;

FIG. 8 is a graph of normalized daily energy results for the best performing heating circuit (HC2) of the test installation, normalized at 0° C. outdoor temperature in reference to the baseline measurements;

FIG. 9 is a graph of thermal energy used per day by HC2, in function of the average outdoor temperature and with differentiation between day and night for both baseline and experimental operation;

FIG. 10 is a graph of the average supply temperature in function of average outdoor temperature, with differentiation between day and night for both baseline and experimental operation;

FIG. 11 is a graph illustrating underheating in function of average outdoor temperature, for both baseline and experimental operation.

### EMBODIMENTS OF THE INVENTION

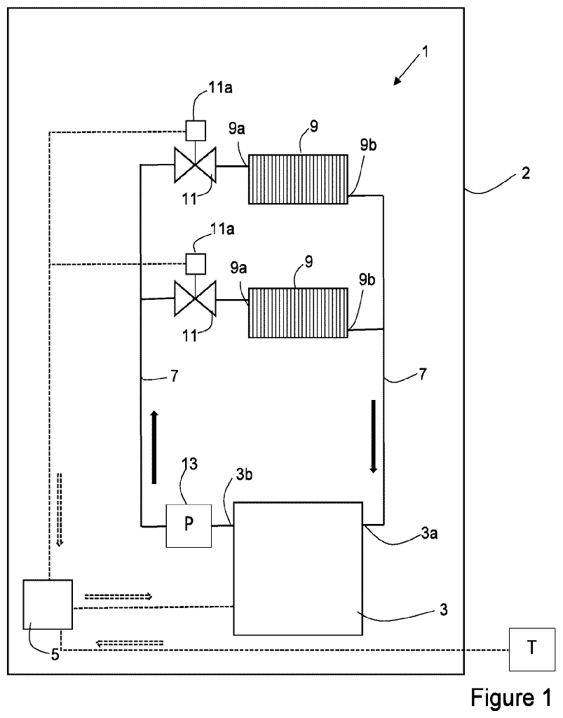

FIG. 1 illustrates schematically a first embodiment of a heat supply system 1 upon which the method of the invention can be carried out. The direction of fluid and information flows are illustrated with arrows.

Heat supply system 1 is installed in a building 2 and comprises a heat source 3, such as a boiler (gas, electric, oil, solid fuel) or a heat pump, which comprises an inlet 3a and an outlet 3b for a heat transfer fluid such as water with or without additives. The temperature of the heat transfer fluid at the outlet 3b can be determined by a system controller 5, which commands the heat source 3 to heat the heat transfer fluid to a particular temperature, and may also actuate the pump. This is carried out on the basis of a heating curve, i.e. a relation between the outside temperature (i.e. the ambient temperature outside the building 2, for which a corresponding temperature sensor T is provided), and the desired temperature of the heat transfer fluid at the outlet 3b. The heating curve or its offset may vary depending on a certain logic, such as a day/night schedule, with higher outlet 3b temperatures being typically indicated during the day and lower outlet 3b temperatures at night for a given external temperature. System controller 5 may be local or remote (connected e.g. via the Internet or another network), and may be implemented on a general-purpose computer or a specific processer as is generally known.

The heat transfer fluid circulates in a network of conduits 7 to the inlets 9a and from the outlets 9b of at least two heat exchangers 9, which may be radiators, forced convection heat exchangers or similar, in order to exchange heat between the heat transfer fluid and the air. The fluid entering each heat exchanger 9 is controlled by a respective controllable valve 11, which in the present embodiment is a thermostatic valve 11 of the so-called “smart thermostatic valve” type, which may be installed at the inlet 1b or the outlet 9b of each heat exchanger 9 and is adapted to transmit information to the system controller 5, namely the opening position of the valve 11, which is an indirect (i.e. proxy) measurement of the flow rate of the heat transfer fluid. Furthermore, the temperature set point of said valve 11 can also be transmitted to the system controller 5.

Each heat exchanger 9 may be installed in a separate room, or in the same room, and the system 1 may comprise several sets of at least two heat exchangers 9 arranged in parallel, the conduits 7 associated with each set being commonly referred to as a “riser”. The presence of supplemental heat exchangers 9 without smart thermostatic valves 11 (or other controllable valves 11) on any given riser is not excluded, however at least two heat exchangers 9 provided with smart thermostatic valves 11 are required. Furthermore, a buffer tank can be present.

The circulation of fluid through the conduits 7 and the heat exchangers 9 is assured by means of a pump 13, here illustrated as being situated on the outlet 3b side of the heat source 3, but which may alternatively be situated on the inlet 3a side thereof or integrated therewith.

The thermostatic valves 11 are adjustable by their respective valve controller 11a between a fully-closed position, in which no heat transfer fluid can pass therethrough, and a fully-open position, in which a minimum of resistance to the passage of heat transfer fluid is provided. The proportion of the maximum possible opening to which the valve 11 is opened is referred to as the “opening position”, and can be expressed as a proportion, a percentage, or indeed an angle of opening, and serves as an indirect measurement of the flow rate of heat transfer fluid. To this end, the valve controllers 11a typically comprise a motor such as a stepper motor in order to drive the valve between its two extreme opening positions (fully closed and fully open). The user can set the valve to a desired set temperature, and the valve controller 11a, which also comprises or receives signals from a temperature sensor arranged to measure the air temperature near the heat exchanger or at least in the same room as this latter, opens and closes the valve in order to try to maintain the set temperature.

The valve controllers 11a also comprise a communication interface capable of at least one-way communication by wired or wireless means, as illustrated schematically by dashed lines, in order to communicate the valve opening position and the valve temperature setpoint to the system controller 5. Optionally, the valve controllers 11a may be arranged to receive commands from the system controller 5 to increase or decrease the set temperature, or to command the valves 11 to open or close more than they would otherwise. Furthermore, the valve temperature set point, as determined by the controller of each valve 11, can also be communicated to the system controller 5.

In simple terms, the system controller 5 receives signals from the valve controllers 11a in real time corresponding to their respective opening positions and hence indirectly to the flow rate of heat transfer fluid, computes a weighted average of these opening positions, and then offsets the heating curve on the basis of this weighted average and a derivative term relating to the valve temperature set point, as will be explained below.

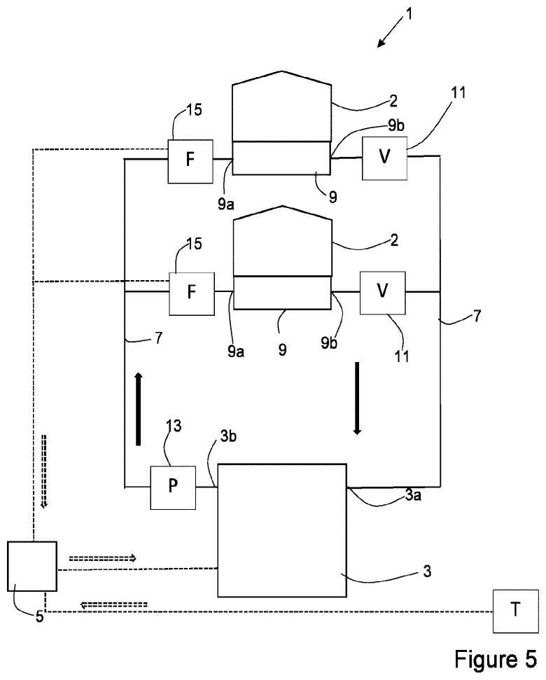

FIG. 5 illustrates a district heating system representing a second embodiment of a heat distribution system 1. The heat distribution system 1 of this figure differs from that of FIG. 1 in that the heat exchangers 9 transfer heat from the network to the heating systems of the individual buildings 2 as is generally known and need not be explained in detail, each heat exchanger 9 being associated with controllable valve 11 and a flow meter 15, each at an inlet 9a or outlet 9b thereof, or integrated therein, the flow meter 15 communicating with the system controller 5. Instead of the valve opening positions being communicated as an indirect flow rate measurement, the flow meters 15 communicate the directly-measured flow rate of heat transfer fluid to the system controller 5 as the building 2 draws more or less heat by varying the flow rate of heat transfer fluid through the heat exchanger 9 by means of the controllable valve 11. In an alternate case, analogous to that of FIG. 1, indirect flow rate measurements based on valve opening positions can be used for a district heating system.

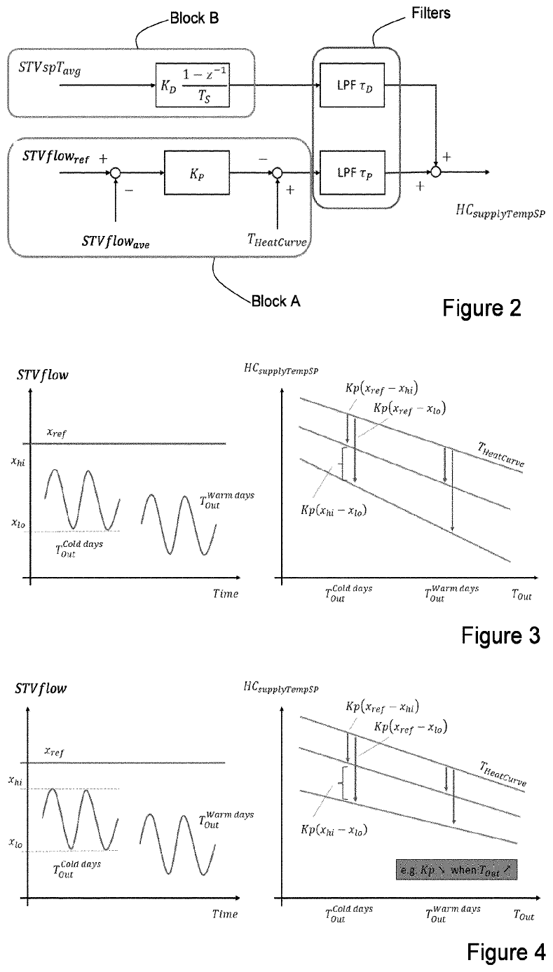

FIG. 2 illustrates a controller model which can be used to carry out the methodology applied in the invention, and is applicable to both types of heat distribution system 1 as illustrated in FIGS. 1 and 5.

The following main parameters are used in the foregoing (Table 1):

| Parameters | Units | Description |
|---|---|---|
| Tₒᵤt | K | Outdoor temperature, as measured by |
| | | temperature sensor T |
| T_{HeatCurve} | K | Heating curve temperature (function of Tₒᵤₜ), |
| HC_{supplyTempSP} | K | Heating circuit supply temperature setpoint |
| STVspTₙ | K | Valve n temperature setpoint |
| STVspT_{avg} | K | Average valve 11 temperature setpoint |
| STVflowₙ | % | Direct or indirect flow rate measurement |
| | | relating to valve n, i.e. its opening position in |
| | | the embodiment of figure 1 or the flow rate as |
| | | measured by the associated corresponding flow |
| | | rate meter 15 in the embodiment of figure 5 |
| | | (applies equally to all instances of ″direct or |
| | | indirect flow rate measurement) below |
| STVflow_{avg} | % | Average direct or indirect flow rate |
| | | measurement relating to all valves 11 |
| STVflow_{ref} | % | Valve direct or indirect flow rate reference |
| Kₚ | — | Proportional gain for the controller |
| K_{D} | — | Derivative gain for the controller |
| τₚ | S | Low-pass filter time constant for the |
| | | proportional terms |
| τ_{D} | S | Low-pass filter time constant for the derivative |
| | | terms |
| wtₙ | — | Weight attributed to valve n temperature |
| | | setpoint |
| wpₙ | — | Weight attributed to valve n direct or indirect |
| | | flow rate measurement |
| Z | | Number of sample shifts (in the z-transform) |
| T_{S} | S | Sampling time |
| N | — | Total number of controllable valves 11 |
| n | — | Indication of a particular controllable valve 11 |

In a conventional system, the desired outlet temperature (i.e. outlet temperature setpoint HC_{supplyTempSP}) is simply determined by a heating curve, that is to say, by a simple relationship between the outdoor temperature Tₒᵤₜ and the outlet temperature, given by T_{HeatCurve}. The method of the present invention builds on this basic concept, treating T_{HeatCurve} as a raw outlet temperature, that is to say the value of HC_{supplyTempSP} that would be given in the traditional case, in the absence of the additional aspects of the invention, and adjusting it in order to obtain an outlet temperature which is optimized.

The controller illustrated comprises a feedforward calculation block (Block A) which takes the raw outlet temperature based on a linear heating curve (T_{HeatCurve}, inversely proportional to the outdoor temperature Tₒᵤₜ), to which is added an offset. This offset is proportional to the difference between a valve direct or indirect flow rate reference STVflow_{ref}, which is typically close to 100% of the maximum flow rate (whether determined empirically by the flow rate meter 15 or on the basis of the valve 11 opening position) and the average of the direct or indirect flow rate measurements associated with all valves 11 concerned STVflow_{avg} so as to effectively obtain an adjusted heating curve, although in fact an offset is applied to a heating curve which does not vary. It is noted that in the foregoing, “valve(s) 11” relates to the controllable valves 11 incorporated in a given heat supply system 1, other valves which are present but which are not involved in the method of the invention are ignored. The sum of the raw outlet temperature and the offset is referred to as an offset raw outlet temperature, and is such that when STVflow_{avg} increases, the weighted average increases, and vice-versa. The outlet temperature HC_{supplyTempSP} IS determined on the basis of this offset raw outlet temperature, either directly or via further signal processing, as will become clear below.

In addition, a derivative calculation block (Block B) takes the average valve 11 temperature setpoint STVspT_{avg} and calculates the first differential thereof, via a transfer function

$${K}_{D} \frac{1 - {z}^{- 1}}{{T}_{S}}$$

or by any other convenient calculation. This first differential deviates from zero whenever one or more of the valve 11 temperature setpoints has a transition and hence varies, whether this is due to user intervention or automatically, e.g. during the transition from a day setpoint to a night setpoint or vice-versa. This first differential is then used in order to manipulate the outlet temperature so that the measured temperatures reach the desired temperature setpoints of the valves 11 sooner than they would in the absence of Block B, as will become apparent below. Both the offset raw outlet temperature and the first differential are low-pass filtered (Filters) in order to prevent rapid cycling, unwanted oscillation of the valve 11 setpoints etc. The controlled supply temperature setpoint of the heat generator HC_{supplyTempSP}, and hence the outlet temperature, is the sum of the filtered proportional and derivative terms.

The controller action is hence summarized as follows:
When the STVflow_{avg} decreases [symbol] , the HC_{supplyTempSP} decreases [symbol] .
When the STVflow_{avg} increases [symbol] , the HC_{supplyTempSP} increases [symbol] .

For the feedforward calculation block (Block A), the average valve 11 direct or indirect flow rate STVflow_{avg} is defined as:

$${STVflow}_{avg} = \frac{1}{N} {\sum }_{n = 1}^{N} {wp}_{n} {STVflow}_{n} , \qquad Equation 3$$

where N is the number of valves, STVflowₙ the valve n flow rate measurement (i.e. the directly-measured flow rate or the indirectly-measured flow rate relating to the valve opening position), and wpₙ the weight attributed to the valve n. In the normal case, wpₙ=1 for all n, however this can be modified if required, for instance in the case in which a particular valve 11 should be taken less into account or not taken into account at all, at which point wpₙ can be smaller or zero for that valve 11. In principle, its value can also be larger than 1. An example of a higher weighting for a valve is the case in which there is a lack of user comfort in a room associated with a particular heat exchanger, for instance if there is no significant response if the user increases the temperature setpoint. This can be remedied by increasing the weighting of the valve in question. A lower weighting may be indicated in the case in which a particular valve malfunctions, or its setpoint is set incorrectly by the user.

For the derivative calculation block (Block B), the average temperature setpoint STVspT_{avg} of the controllable valves 11 is defined as:

$${STVspT}_{a v g} = \frac{1}{N} {\sum }_{n = 1}^{N} w {t}_{n} {STVspT}_{n} , \qquad Equation 4$$

where N is the number of valves 11, STVspTₙ the valve n temperature setpoint, and wtₙ the weight attributed to the valve n. In the normal case, wtₙ=1 for all n.

For the feedforward calculation block (Block A), the parameters are the proportional gain K_{P} and the controllable valve direct or indirect flow rate reference STVflow_{ref}. The low-pass filter LPF τ_{P} is set as 1^{st} or 2^{nd} order LP filter with time constant τ_{P}.

For the derivative calculation block of the controller (Block B), the parameter is the derivative gain K_{D}. The low-pass filter LPF τ_{D} is set as 1^{st} or 2^{nd} order LP filter with time constant τ_{D}.

In a conventional approach, a day/night temperature schedule is usually provided at the heat generator 3 level, programmed into its controller 5. This serves to reduce the outlet 3b temperature setpoint at night when heating requirements are typically less.

The method of the invention, however, permits day/night schedules to be programmed into each valve controller 11a, enabling the day/night schedule to be customized to each room and/or each heat exchanger 9, the outlet temperature of the heat source 3 being automatically adjusted as required, according to the method of the invention. A lower set temperature at night translates into a lower valve 11 opening, which the controller processes to control HC_{supplyTempSP} accordingly. This further reduces the risk of user complaints of being too cold while saving energy compared to a classic approach, since the user can determine the settings of each individual valve 11.

The setting of the controller parameters K_{P} and STVflow_{ref} offer the possibility to get the required day/night profile for the supply temperature setpoint HC_{supplyTempSP} of the heat generator. It should be noted that for K_{D} this is not required.

Parameter estimation can be carried out by means of the following linear least-squares (LS) problem:

$$Equation 5$$

$${min}_{{x}_{1} , {x}_{2}} {‖ {HC}_{sup plyTempSP} ( {t}_{k} ) - {T}_{HeatCurve} ( {t}_{k} ) + {x}_{1} - {x}_{2} {STVflow}_{a v g} ( {t}_{k} ) ‖}_{2}^{2}$$

$$where$$

$${STVflow}_{r e f} = {x}_{1} / {x}_{2} and {K}_{P} = {x}_{2} . \qquad Equation 6$$

Or, formulated in matrix form:

$${min}_{x} {‖ y - Ax ‖}_{2}^{2} \qquad Equation 7$$

$$with$$

$$y = {HC}_{supplyTempSP} ( {t}_{k} ) - {T}_{HeatCurve} ( {t}_{k} ) \qquad Equation 8$$

$$and$$

$$A = {[ \begin{matrix}{1}_{1 \times K} \\ {STVflow}_{avg}^{T} ( {t}_{k} )\end{matrix} ]}^{T} \qquad Equation 9$$

$$to get the solution$$

$$x = [ \begin{matrix}{x}_{1} \\ {x}_{2}\end{matrix} ] \qquad Equation 10$$

with STVflow_{ref} and K_{P} obtained by Equation 6

Time-series f (t) are discretized at time instant tₖ=kT_{S} with time index k=1 . . . K and sampling rate T_{S}.

A heuristic dimensioning based on sampling time and delta T (set-point-measured) can be carried out if desired, as follows. The parameter K_{D} is set to get an increase of the heating circuit supply temperature setpoint HC_{supplyTempSP}.

HC_{supplyTempSP} is proportional to the change in the average valves 11 temperature setpoint STVspT_{avg}. The increase of the heating circuit supply temperature setpoint is equivalent to the ratio of the difference between two samples of the average valves 11 temperature setpoint and the sampling time T_{S} times the parameter K_{D}:

$${HC}_{supplyTempSP} ( {t}_{k} ) - {HC}_{supplyTempSP} ( {t}_{k - 1} ) = {K}_{D} \frac{{STVspT}_{avg} ( {t}_{k} ) - {STVspT}_{avg} ( {t}_{k - 1} )}{{T}_{S}} ,$$

and then, the parameter K_{D} is formulated as:

$${K}_{D} = {T}_{S} \frac{{HC}_{supplyTempSP} ( {t}_{k} ) - {HC}_{supplyTempSP} ( {t}_{k - 1} )}{{STVspT}_{avg} ( {t}_{k} ) - {STVspT}_{avg} ( {t}_{k - 1} )} ,$$

assuming that the proportional term is not considered in HC_{supplyTempSP}.

An adaptive scheme is proposed below to tune the parameters and get improvement for the whole winter season in any building 2. The outdoor temperature T is reflected in the heating curve T_{HeatCurve} as mentioned above. However, to further take into account the influence of the mid-season with mild outdoor temperature Tₒᵤₜ, an adaptive scheme can be included to the STVflow_{ref} and K_{P} parameters estimation based on long-term (i.e. a few days) low-pass filtered outdoor temperature Tₒᵤₜ.

$${K}_{P} = {K}_{P}^{{T}_{min}} ( 1 - α ( {T}_{o u t} ) ) + {K}_{P}^{{T}_{max}} α ( {T}_{o u t} ) \qquad Equation 11$$

$${STVflow}_{ref} = {STVflow}_{ref}^{{T}_{min}} ( 1 - α ( {T}_{o u t} ) ) + {STVflow}_{ref}^{{T}_{max}} α ( {T}_{o u t} )$$

$$where$$

$$α ( {T}_{o u t} ) = \frac{{T}_{o u t} - {T}_{min}}{{T}_{max} - {T}_{min}}$$

$${{and \begin{matrix}{K}_{P}^{{T}_{min}} \\ {STVflow}_{ref}^{{T}_{min}}\end{matrix} \vert}_{{T}_{out}^{min}} and \begin{matrix}{K}_{P}^{{T}_{max}} \\ {STVflow}_{ref}^{{T}_{max}}\end{matrix} \vert}_{{T}_{out}^{max}} \qquad Equation 12$$

This adaptive scheme offers a linear parameter varying scheme between two sets of parameters, K_{P} and STVflow_{ref}, at two different seasons, e.g. winter and mid-season for which the offset applied to the heating curve has a different correction. This difference can be highlighted from the parameter identification as described above.

The effect of this adaptive scheme is visible by comparing FIG. 3, which illustrates the case with fixed parameters K_{P} and STVflow_{ref}, with FIG. 4, which illustrates the case in which parameter K_{P} decreases during the warmer mid-season, and hence effectively flattens the heating curve by applying less gain to its offset.

More specifically, for a fixed parameter K_{P}, the HC_{supplyTempSP} (t) will be further below T_{Heatcurve}(t) when STVflowₐᵥₑ becomes much lower than STVflow_{ref}. This is illustrated in FIG. 3 by the

$${T}_{o u t}^{Warm days}$$

scenario compared to the

$${T}_{o u t}^{Cold days}$$

scenario. In the case one want to avoid that HC_{supplyTempSP}(t) goes further below T_{Heatcurve}(t) when STVflowₐᵥₑ becomes much lower than STVflow_{ref} for the

$${T}_{o u t}^{Warm days}$$

scenario, then an adaptative scheme can decrease the parameter K_{P} value when outdoor temperatures Tₒᵤₜ, are increasing. This latter case is illustrated in FIG. 4.

The methodology described above results in the valves 11 being on average more open than under a classical approach, with higher flow rates and lower outlet temperature of the heat source 3, resulting in lower inlet temperatures for this latter, increasing its coefficient of performance and reducing user complaints of being too cold.

### Implementation Example

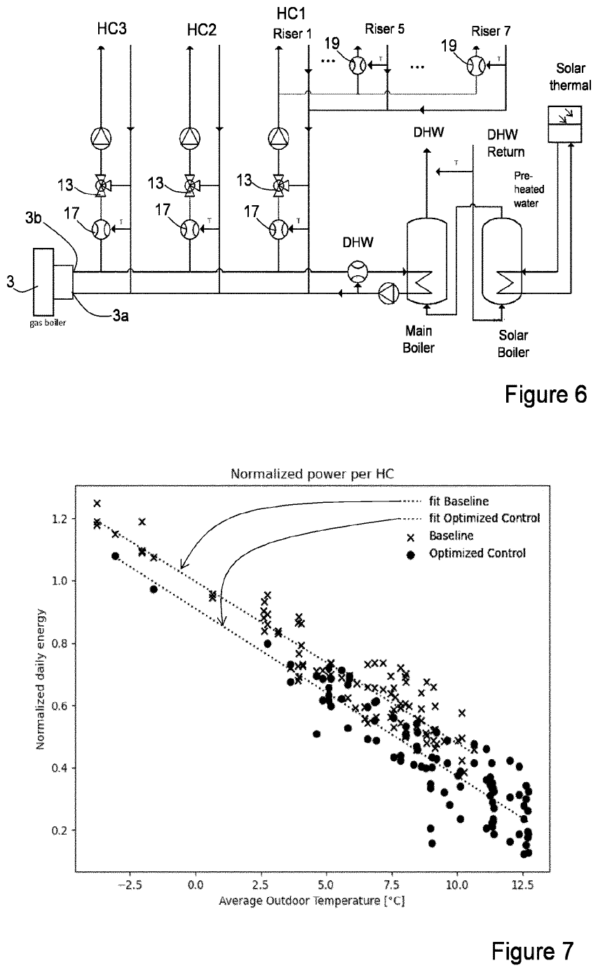

A test site was selected, whose heating system is schematically represented in FIG. 6. The test site is a mixed, residential and tertiary, building. The ground floor is composed of an office and two shops, the four floors above host six apartments.

The building heat is generated by heat source 3, which is a gas condensing boiler (Logamax from Buderus) that can provide a heating power up to 82 kW and serves for space heating and domestic hot water (DHW) production. Given the building layout, three independent heating circuits (HC1, HC2 and HC3) each equipped with an independent heat meter 17 and mixing valve 13 are used. In addition, DHW heating power is also monitored. A solar thermal system is also provided. Furthermore, heating circuit HC1 comprises three risers, of which risers 5 and 7 are equipped with a further heat meter 19 which is downstream of HC1's heat meter 17. Heating circuits HC2 and HC1 supply living spaces with one and six apartments respectively, whereas heating circuit HC3 supplies a workshop for daily activities.

The gas boiler default heating curve set-point can be bypassed thanks to the KM200 gateway from Buderus. This device allows setting the target forward temperature of each heating circuit HC1, HC2, HC3 independently. The system controller 5 is integrated in the gas boiler 3 and oversees generating the heat and driving the mixing valves 13. In other words, the heat controller algorithm of the invention sends three desired temperature set-points (one per heating-circuit) and the system controller 5 modulates the power of the boiler 3 and regulates the mixing valves 17 as required. The default heating curve is defined as an inversely proportional relationship between the desired forward heating temperature relating to each heating circuit and the outdoor temperature.

The heat exchangers 9 are standard steel radiators (not illustrated in FIG. 6; see FIG. 1), equipped with smart thermostatic valves 11 (SmartDrive MX from HORA and Vicki from MClimate) installed on all radiators 9, with 14, 5 and 50 units respectively for each heating circuit HC2, HC3, and HC1. Among the measured values, the room temperature, room temperature set-point and valve percentage opening are the most critical for the algorithm and analysis of the results, and these are transmitted wirelessly to the system controller 5.

Parameter and numerical values used in the implementation are summarized in Table 1

TABLE 1
Parameters in the implemented solution

| | HC2 | | HC3 | | HC1 | |
|---|---|---|---|---|---|---|
| Nbr of heat | 14 | | 5 | | 50 | |
| exchangers N | 80 | | 110 | | 50 | |
| STVpos_{ref} [%] | | | | | | |
| Kₚ, τₚ, order | 0.4, 2 | h, 2^{nd} | 0.2, 2 | h, 2^{nd} | 0.3, 2 | h, 2^{nd} |
| Kₚ, τ_{D}, order | 7, 2 | h, 2^{nd} | 7, 2 | h, 2^{nd} | 7, 2 | h, 2^{nd} |
| Day/night * | 9-22 | h | 7-19 | h | 9-22 | h |

* day/night schedule can be different for each heat exchanger 9 in a given heating circuit. In this table, day/night schedule values are just an indication of the most common radiator schedule in the specific heating circuit.

Key performance indicators (KPI) were defined to assess the thermal energy and comfort:
Energy KPI—Daily thermal energy versus average outdoor temperature. Daily thermal energy per heating circuit is computed as the integration over one day of the thermal power at heating circuit mixing valve level. The total energy consumed at building level is the sum of energy at mixing valves level. The units of energy KPI are kWh per day [kWh/d].
Comfort KPI—Underheating and overheating versus average outdoor temperature. Under/overheating is computed as the difference between the measured room temperature Tᵣₒₒₘ and the valve temperature set-point Tₛₚ. Daily underheating is the integration over one day of the min

$$( {T}_{r o o m} - {T}_{sp}^{clip} , 0 )$$

averaged over all valves 11, while daily overheating is the integration over one day of the max

$$( {T}_{r o o m} - {T}_{sp}^{clip} , 0 )$$

averaged over an valves 11. To avoid artifacts from out-of-range values from the valve temperature set-point the feasible values were limited in between 16° C. and 24° C., i.e.

$${T}_{sp}^{clip} = clip ( {T}_{s p} , 16 , 24 ) .$$

Units of underheating/overheating are Kelvin hours per day [Kh/d].

These two KPIs are used to evaluate the energy consumption and comfort of the proposed solution. KPIs are computed for both the baseline case, in which the boiler's controller operates conventionally, and the proposed solution of the invention. For the baseline, a standard heating curve is used to drive the three heating circuits HC1, HC2, HC3, and in consequence the heat generator 3. To allow a relevant energetic comparison between baseline and controlled periods, the comfort levels are to be similar (or better for the controlled periods), and energy savings shall not come from a degraded comfort, i.e. simply running each heating circuit H1, H2, H3 cooler without using the method of the invention.

To evaluate the proposed STV data-driven heat controller and compare it with the baseline, measurements were taken during the winter-spring 2021 seasons from January 15th to Jun. 31, 2021.

During the preliminary development stage, initial measurements from 15.01.2021 to 12.02.2021 are composed only of baseline data. Then, once the data-driven control algorithm was getting ready, the data-driven heat controller was gradually activated on each heating circuit:
HC2 starting from 12.02.2021
HC3 starting from 03.03.2021
HC1 starting from 23.04.2021

In addition, the system was reverted to baseline operation from time to time in order to have a representative mix of baseline and experiment data spread over a range of outdoor temperatures from winter to spring.

The analysis can be further discriminated between day and night schedules for each heating circuit HC1, HC2, HC3. The day/night schedule refers to the settings entered by the users at valve 11 level. These settings remain the same during the baseline operation and optimized control operation. The configuration of each heating circuit with the number of radiators, day schedule is found in Table 2 above. The number of baseline days and experiment days are for each heating circuits are:

| | HC2 | HC3 | HC1 |
|---|---|---|---|
| # baseline days: | 30 | 19 | 48 |
| # experiment days: | 69 | 56 | 38 |

The result for the whole building is provided in FIG. 7, where the energy is normalized at 0° C. outdoor temperature, in reference to the baseline, and the three heating circuits H1, H2, H3 have been aggregated, so that the whole building energy can be compared between the proposed optimized solution and the baseline. Qualitatively, the thermal power consumption is reduced by 15% for the proposed solution based on the regression at 5° C. outdoor temperature.

Global underheating and overheating averaged over all baseline days and experiments days are computed and summarized in Table 3 for underheating and overheating. As a general point, the focus is primarily on underheating, since the aim is to reduce energy consumption and hence the risk of underheating is greater. Furthermore, overheating is generally prevented by each valve 11, since this is thermostatic and will reduce the flow of heat transfer fluid if the room temperature rises above its setpoint.

TABLE 2
Comfort KPIs for underheating and overheating

| | Underheating | | | Overheating | | |
|---|---|---|---|---|---|---|
| | HC2 | HC3 | HC1 | HC2 | HC3 | HC1 |
| Baseline | −0.72 | −0.88 | −0.31 | 0.26 | 0.48 | 0.64 |
| Experiment | −0.81 | −0.93 | −0.19 | 0.34 | 0.46 | 1.22 |
| Delta | −0.09 | −0.05 | 0.12 | 0.08 | −0.02 | 0.58 |

These results show that underheating and overheating are similar between baseline and experiments for heating circuits HC2 and HC3. For underheating, a value of −0.5 is to be interpreted as: “the average of the valves of the considered heating circuit are 0.5K below the desired set-point over one day”.

The 15% energy saving mentioned above is not linked to underheating. Indeed, for HC2 and HC3 the underheating difference between baseline and experiments is only 0.09 Kh/day and 0.05 Kh/day. Such small differences do not induce 15% energy reduction. Indeed, on average one expects a 1° C. indoor temperature difference to impact the energy expenditure by ~7%. It is hence clear that the method of the invention engenders significant energy savings without increasing underheating to any meaningful degree.

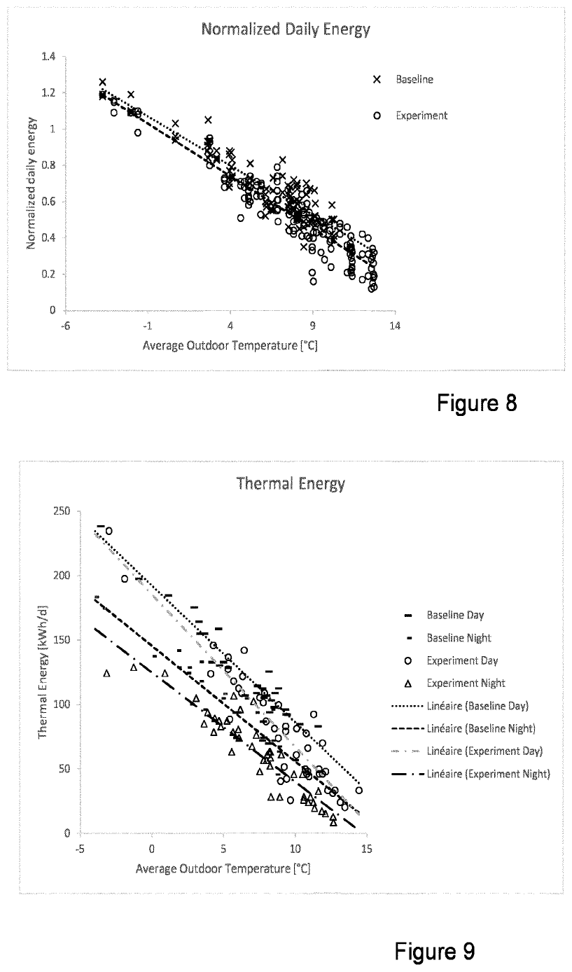

Further evidence of the effect of the invention is given in the graphs of FIGS. 8-11, which represent measurements taken on the heating circuit with the highest performance, HC2.

These graphs illustrate the following measures:

FIG. 8: normalized daily energy in function of average outdoor temperature, normalized at 0° C. outdoor temperature in reference to the baseline measurements. As can clearly be seen, the energy consumption trend for the experimental values (dashed line) is lower than for the baseline measurements (dotted line).

FIG. 9: thermal energy used per day in kWh/d, in function of the average outdoor temperature and with differentiation between day and night for both baseline and experimental operation. The trendline for each of day and night shows significant improvement (i.e. reduced energy consumption) for the corresponding experimental values compared to the corresponding baseline values under conventional operation.

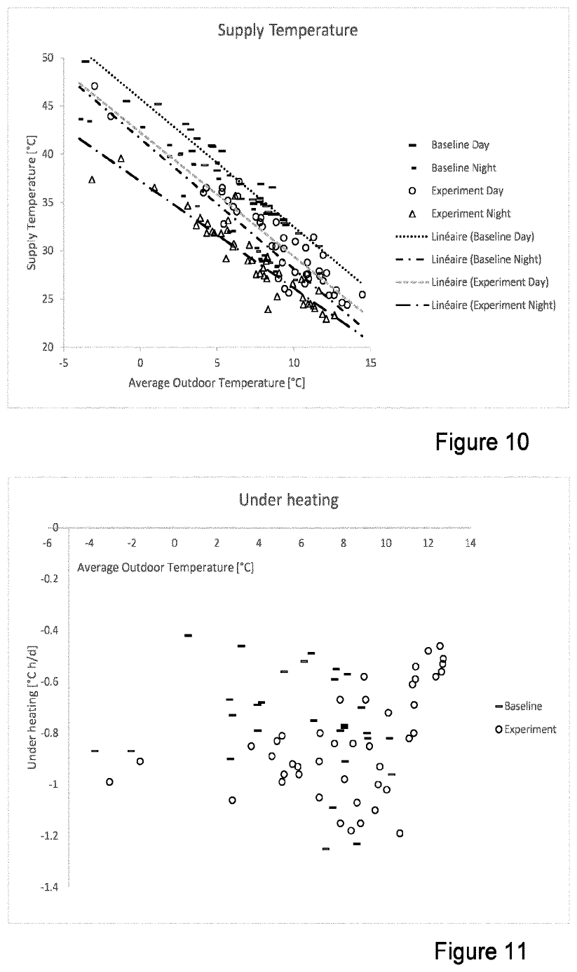

FIG. 10: average heat transfer fluid supply temperature in function of average outdoor temperature, with differentiation between day and night for both baseline and experimental operation. Again, for each of day and night operation, the supply temperature is lower for the experimental values than the baseline values, indicating lower temperature heat transfer fluid at higher flow rates and valves 11 being more open for the experimental operation than for baseline operation.

FIG. 11: underheating in ° Ch/d in function of average outdoor temperature, for both baseline and experimental operation. No trendlines have been placed, since this graphic is effectively a cloud of points. If anything, underheating is trivially worse for the experimental values, which is tolerable given the significant improvement regarding the other measures of FIGS. 7-8.

Although the invention has been described in terms of specific embodiments, variations thereto are permitted without departing from the scope of protection as defined in the appended claims.

1. A method of operating a heat supply system, the heat supply system comprising:
a heat source adapted to heat a heat transfer fluid;
a system controller adapted to control said heat source so as to determine an outlet temperature of said heat transfer fluid at an outlet of said heat source based on a heating curve defining a raw outlet temperature of said heat source in inverse proportion to an outside temperature; and
at least two heat exchangers, each of the at least two heat exchangers being configured to receive said heat transfer fluid and being provided with a respective controllable valve at an inlet or outlet of the respective one of the at least two heat exchangers, each said controllable valve being associated with a direct or indirect flow rate measurement transmitted to said system controller;
wherein said method comprises said system controller carrying out steps of:
receiving signals relating to said direct or indirect flow rate measurements associated with said controllable valves corresponding to the controllable valve's current respective direct or indirect flow rate measurements;
calculating a weighted average of said direct or indirect flow rate measurements;
adding an offset to said raw outlet temperature based on said weighted average to generate an offset raw outlet temperature such that a decrease in said weighted average causes a decrease in said offset raw outlet temperature, and an increase in said weighted average causes an increase in said offset raw outlet temperature; and
determining said outlet temperature based on said offset raw outlet temperature.

2. The method according to claim 1, wherein said weighted average weights each said controllable valve equally.

3. The method according to claim 1, wherein said offset is determined based on a difference between a valve direct or indirect flow rate reference STVflow_{ref} and the weighted average of said direct or indirect flow rate measurements of all of said controllable valves STVflow_{avg}.

4. The method according to claim 3, wherein said average of said direct or indirect flow rate measurements of all of said controllable valves STVflow_{avg} is defined as:
$${STVflow}_{a v g} = \frac{1}{N} {\sum }_{n = 1}^{N} {wp}_{n} {STVflow}_{n} , \qquad Equation 1$$
where
N is a number of controllable valves,
STVflowₙ is the valve n direct or indirect flow rate measurement, and
wpₙ is the weight attributed to the valve n.

5. The method according to claim 3, further comprising low-pass filtering said offset raw outlet temperature to generate a filtered offset raw outlet temperature, said outlet temperature being based on said filtered offset raw outlet temperature.

6. The method according to claim 3, further comprising amplifying and low-pass filtering the first differential of the average controllable valve temperature setpoint STVspT_{avg}, then adding the amplified and low-pass filtered result to said filtered offset raw outlet temperature to determine said outlet temperature.

7. The method according to claim 6, wherein said average controllable valve temperature setpoint STVspT_{avg} is defined as:
$${STVspT}_{a v g} = \frac{1}{N} {\sum }_{n = 1}^{N} {wt}_{n} {STVspT}_{n} , \qquad Equation 2$$
where
N is the number of valves,
STVspTₙ is the valve n temperature setpoint, and
wtₙ is the weight attributed to the valve n.

8. The method according to claim 3, wherein a gain K_{P} is applied to said difference between a given said valve direct or indirect flow rate reference STVflow_{ref} and the average of the direct or indirect flow rate measurements of all of said controllable valves STVflow_{avg}.

9. The method according to claim 8, wherein said gain K_{P} is lower during a warmer season, and higher during a cooler season.

10. The method according to claim 1, wherein day/night variation in heat supply is obtained exclusively by varying each controllable valve temperature setpoint.

11. The method according to claim 1, wherein said controllable valves are thermostatic valves, and said direct or indirect flow rate measurement is related to an opening position of each of said controllable valves.

12. The method according to claim 1, wherein said controllable valves are each associated with a respective flow rate meter, and said direct or indirect flow rate measurement is a flow rate measured by each of said flow rate meters.

13. A heat supply system comprising:
a heat source adapted to heat a heat transfer fluid;
a system controller adapted to control said heat source so as to determine an outlet temperature of said heat transfer fluid at an outlet of said heat source based on a heating curve defining a raw outlet temperature of said heat source in inverse proportion to an outside temperature; and
at least two heat exchangers, each of the at least two heat exchangers being configured to receive said heat transfer fluid and being provided with a respective controllable valve at an inlet or outlet of the respective one of the at least two heat exchangers, each said controllable valve being associated with a direct or indirect flow rate measurement transmitted to said system controller;
wherein said heat supply system is adapted to be operated according to a method comprising said system controller carrying out steps of:
receiving signals relating to said direct or indirect flow rate measurements associated with said controllable valves corresponding to the controllable valve's current respective direct or indirect flow rate measurements;
calculating a weighted average of said direct or indirect flow rate measurements;
adding an offset to said raw outlet temperature based on said weighted average to generate an offset raw outlet temperature such that a decrease in said weighted average causes a decrease in said offset raw outlet temperature, and an increase in said weighted average causes an increase in said offset raw outlet temperature; and
determining said outlet temperature based on said offset raw outlet temperature.

14. The method according to claim 4, further comprising amplifying and low-pass filtering a first differential of the average controllable valve temperature setpoint STVspT_{avg}, then adding said amplified and low-pass filtered result to said filtered offset raw outlet temperature to determine said outlet temperature.

15. The method according to claim 14, wherein said average controllable valve temperature setpoint STVspT_{avg} is defined as:
$${STVspT}_{a v g} = \frac{1}{N} {\sum }_{n = 1}^{N} {wt}_{n} {STVspT}_{n} , \qquad Equation 3$$
where
N is the number of valves,
STVspTₙ is the valve n temperature setpoint, and
wtₙ is the weight attributed to the valve n.

16. The method according to claim 4, further comprising applying a gain K_{P} to said difference between a valve direct or indirect flow rate reference STVflow_{ref} and the average of the direct or indirect flow rate measurements of all of said controllable valves STVflow_{avg}.

17. The method according to claim 5, further comprising applying a gain K_{P} to said difference between a valve direct or indirect flow rate reference STVflow_{ref} and the average of the direct or indirect flow rate measurements of all of said controllable valves STVflow_{avg}.

18. The method according to claim 6, further comprising applying a gain K_{P} to said difference between a valve direct or indirect flow rate reference STVflow_{ref} and the average of the direct or indirect flow rate measurements of all of said controllable valves STVflow_{avg}.

19. The method according to claim 7, further comprising applying a gain K_{P} to said difference between a valve direct or indirect flow rate reference STVflow_{ref} and the average of the direct or indirect flow rate measurements of all of said controllable valves STVflow_{avg}.

20. The method according to claim 19, wherein said gain K_{P} is lower during a warmer season, and higher during a cooler season.
